(19) United States
(12) Patent Application Publication
(10) Pub. No.: US 2013/0218685 A1
(43) Pub. Date: Aug. 22, 2013

(54) Offering an Object For Sale

(71) Applicants: Joakim FORMO, Akersberga (SE); Marcus Gárdman, Skarholmen (SE)

(72) Inventors: Joakim FORMO, Akersberga (SE); Marcus Gárdman, Skarholmen (SE)

(73) Assignee: Telefonaktiebolaget L M Ericsson (publ), Stockholm (SE)

(21) Appl. No.: 13/398,308

(22) Filed: Feb. 16, 2012

(51) Int. Cl. G06Q 30/02

(52) U.S. Cl. 705/14.66; 705/14.4; 705/27.2

(57) ABSTRACT

A method performed by a network management node for offering an object for sale is disclosed. The network management node receives a sales offering request message from a user equipment, wherein the sales offering request message requests the network management node to offer a specific object for sale. In a subsequent step, information about the specific object is gathered from a unique network entity profile associated with the specific object, i.e. the object intended for sale. A sales ad is thereafter generated in step. The sales ad is generated on the basis of the gathered information about the object. Embodiments of the present invention presented herein also relate to methods, network management nodes, user equipments, systems, computer programs and computer program products for offering an object for sale.

### TECHNICAL FIELD

Embodiments of the present invention presented herein generally relate to methods, network management nodes, user equipments, systems, computer programs and computer program products for offering an object for sale.

### BACKGROUND

U.S. Pat. No. 5,960,411 relates to a method and system for placing a purchase order via a communications network. As is disclosed in the abstract of the U.S. Pat. No. 5,960,411, the order is placed by a purchaser at a client system and received by a server system. The server system receives purchaser information including identification of the purchaser, payment information, and shipment information from the client system. The server system then assigns a client identifier to the client system and associates the assigned client identifier with the received purchaser information. The server system sends to the client system the assigned client identifier and an HTML document identifying the item and including an order button. The client system receives and stores the assigned client identifier and receives and displays the HTML document. In response to the selection of the order button, the client system sends to the server system a request to purchase the identified item. The server system receives the request and combines the purchaser information associated with the client identifier of the client system to generate an order to purchase the item in accordance with the billing and shipment information whereby the purchaser effects the ordering of the product by selection of the order button.

In today's solutions such as Amazon.com, Craiglist.org, eBay.com, or Blocket.se, a user (seller) must create a sales advertisement, also known as a sales ad or simply ad, manually. That is to say that any information, such as product information, information about warranties, information about earlier services or upgrades, etc. related to the object that is offered for sale has to be manually provided and submitted by the seller. The process of manually entering this information when selling objects via a network, e.g. the Internet, may be perceived as cumbersome by some users. Furthermore, this process consumes a certain amount of time. Moreover, the process may sometimes require fairly skilled users that need a certain level of computer skills in order to complete the process of offering an object for sale.

### SUMMARY

It is in view of the above considerations and others that the various embodiments of the present invention have been made. The inventors have realized that there is a need for a facilitated technique for offering objects for sale via a network.

In view of the above, it is therefore a general object of the various embodiments of the present invention to facilitate the process of offering objects for sale.

The various embodiments of the present invention as set forth in the appended claims address this general object.

According to a first aspect, there is provided a method performed by a network management node for offering an object for sale. The network management node is connected to a plurality of objects via a network. Furthermore, each of the plurality of objects is associated with a unique network entity profile, which comprises static information pertaining to the object. The method comprises receiving a sales offering request message from a user equipment, UE, the sales offering request message requesting the network management node to offer a specific object of the plurality of objects for sale; gathering static information about the specific object from the unique network entity profile associated with the specific object; and generating a sales advertisement, ad, for the specific object on the basis of the gathered static information about the object.

Optionally, the method may further comprise gathering dynamic information about the specific object. If so, the step of generating the sales ad may further comprise generating the sales ad for the specific object on the basis of the gathered dynamic information about the object.

Moreover, the method may optionally further comprise gathering information about a user associated with the user equipment from which the sales offering request is received. If so, the step of generating the sales ad may further comprise generating the sales ad for the specific object on the basis of the gathered data about said user associated with the user equipment.

Optionally, the sales offering request may additionally comprise an information element for requesting a publishing action. If so, the method may further comprise sending a publish request for publishing the generated sales ad, such that the indicated object is offered for sale.

According to a second aspect, there is provided a network management node for offering an object for sale. The network management node is connectable to a plurality of objects via a network. Each of the plurality of objects is associated with a unique network entity profile comprising static information pertaining to the object. The network management node comprises a communication interface configured to receive a sales offering request message from a user equipment, UE. This sales offering request message requests the network management node to offer a specific object of the plurality of objects for sale. The network management node, furthermore, comprises a processor and a memory, which stores a computer program comprising computer program code which, when run in the processor, causes the network management node to gather static information about the specific object from the unique network entity profile associated with the specific object; and generate a sales advertisement, ad, for the specific object on the basis of the gathered static information about the object.

In one embodiment, the memory and the computer program code are configured to, with the processor, further cause the network management node to gather dynamic data about the specific object and furthermore generate the sales ad on the basis of the gathered dynamic information about the object.

In one embodiment, the memory and the computer program code are configured to, with the processor, further cause the network management node to gather data about a user associated with a user equipment from which a sales offering request is received and furthermore generate the sales ad on the basis of the gathered data about said user associated with the user equipment.

The sales offering request may optionally comprise an information element for requesting a publishing action. To this end, the memory and the computer program code may be configured to, with the processor, further cause the network management node to send, via the communication interface, a publish request for publishing the generated sales ad.

According to a third aspect, there is provided a method performed by a user equipment, UE, for offering a object for sale. The UE is connected to a network management node, which is connected to a plurality of objects via a network. Each of the plurality of objects comprises a unique network entity profile comprising static information pertaining to the object. The method comprises displaying a plurality of content objects via a user interface of the UE, wherein each of the plurality of content objects is associated with a respective object; detecting a user interaction with one content object displayed on the user interface of the UE, the user interaction comprising a selection of one of the plurality of content objects; associating the user interaction with a sales offering request message for requesting a network management node to offer a specific object associated with the selected content object for sale; sending the sales offering request message to a network management node for thereby requesting the network management node to offer said object for sale.

In one embodiment, the sales offering request comprises an information element for indicating which of the plurality of objects that is offered for sale.

In one embodiment, the sales offering request comprises an information element comprising the unique network entity profile of said object for sale.

The sales offering request may further comprise an information element for requesting a publishing action. If so, the method may further comprise sending a publish request for publishing a sales ad, such that the indicated object is offered for sale.

According to a fourth aspect, there is provided a user equipment, UE, for offering an object for sale. The UE is connectable to a network management node, which is connectable to a plurality of objects via a network. Each of the plurality of objects comprises a unique network entity profile comprising static information pertaining to the object. The UE comprises a user interface configured to display a plurality of content objects, wherein each of the plurality of content objects is associated with a respective object. The UE also comprises a processor, and a memory storing a computer program comprising computer program code which, when run in the processor, causes the UE to: detect a user interaction with one content object displayed at the user interface, the user interaction comprising a selection of one of the plurality of content objects; associate the user interaction with a sales offering request message for requesting a network management node to offer a specific object associated with the selected content object for sale; and send, via a communication interface), the sales offering request message to a network management node for thereby requesting the network management node to offer said object for sale.

The sales offering request may comprise an information element for indicating which of the plurality of objects that is offered for sale.

The sales offering request may additionally comprise an information element comprising the unique network entity profile of said object for sale.

The sales offering request may optionally comprise an information element for requesting a publishing action. If so, the memory and the computer program code may be configured to, with the processor, further cause the UE to send, via the communication interface, a publish request for publishing a sales ad, such that the indicated object is offered for sale.

### BRIEF DESCRIPTION OF THE DRAWINGS

These and other aspects, features and advantages of the invention will be apparent and elucidated from the following description of embodiments of the present invention, reference being made to the accompanying drawings, in which:

FIG. 1 illustrates a plurality of objects managed by a network management node according to an exemplary embodiment.

FIG. 2 is a schematic diagram illustrating some modules of an embodiment of a user equipment.

FIG. 3 is a schematic diagram illustrating some modules of an embodiment of a network management node.

FIG. 4 is a flow chart illustrating a method performed by a user equipment according to an embodiment of the invention.

FIG. 5 schematically shows one example of a computer program product comprising computer readable means.

FIG. 6 is a flow chart illustrating a method performed by a network management node according to an embodiment of the invention.

FIG. 7 schematically shows one example of a computer program product comprising computer readable means.

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

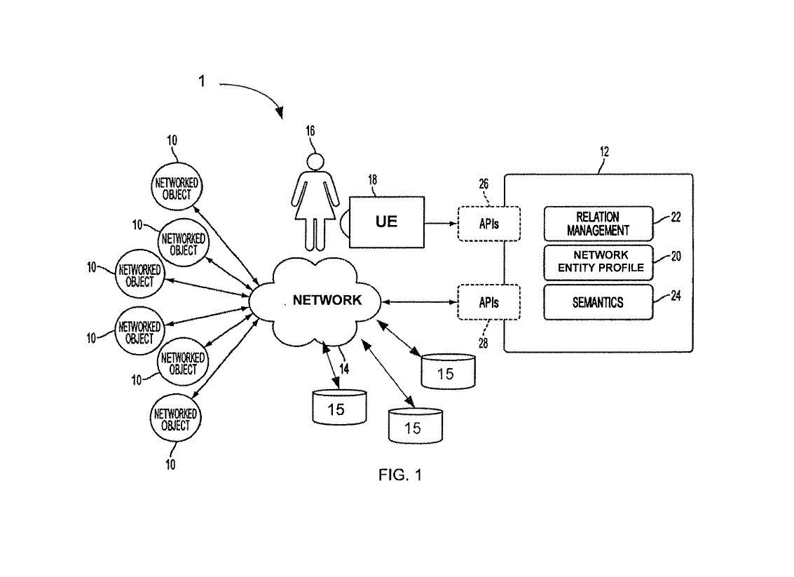

FIG. 1 illustrates an architecture, or system 1, for the mere purpose of putting exemplary embodiments of the present invention into a proper context. This architecture is also presented and discussed in the international PCT-application PCT/IB2010/001167 published on 7 Jul. 2011 under publication number WO 2011/080549. The disclosure of WO 2011/080549 is incorporated herein by reference.

In FIG. 1, a plurality of objects 10 (sometimes referred to as networked objects) is connectable to a node 12, herein referred to as the network management node, via a network 14. The network may be according to a any or a combination of the Internet, a Wireless Area Network (WAN), a Wireless Local Area Network (WLAN), UMTS (Universal Mobile Telecommunications System), CDMA 2000 (Code Division Multiple Access 2000), LTE (Long Term Evolution), GSM (Global System for Mobile Communications), etc. Users 16 can operate and interact with user equipments (UEs) 18. This way, the users 16 can access services provided by the network management node 12 via user interfaces of the UEs 18. The implementation will vary depending on, for instance, the context and the UE 18 on which a particular user interface is running, e.g., the mobile telephones, tablet computers, laptops, televisions or other devices.

The network management node 12, which is configured to manage the objects 10 can, as a mere example, be implemented, at least in part, as server-based software. Users 16 (or more specifically, the UEs associated with the users 16) that are using the network management node 12, can be represented and identified as entities in the network management node 12 by unique profiles, i.e. unique user profiles. The objects 10 can also be represented and identified as entities in the network management node 12 by unique profiles, i.e. unique object profiles. Objects 10 include, but are not limited to: products such as consumer electronics, digitally tagged objects, computer devices, mobile telephones, sensors, buildings, vehicles or even companies, brands, services and physical locations. The above-mentioned unique profiles that represent UEs 18 and objects 10, respectively, in the system 1 are jointly referred to herein as network entity profiles 20.

Information associated with the plurality of objects 10 and/or users 16 can be received by the network management node 12. The node 12 is configured to create network entity profiles 20 for each object 10 and/or user 16 (or, more specifically, UE 18 associated with a certain user 16). As used herein, objects 10 and UEs 18 may commonly be referred to as network entities 10, 18. The network entity profiles 20 may comprise static information pertaining to the network entities in question, i.e. objects 10 or UEs 18. Static information may include, but is not limited to, information such as name, technical specifications, manufacturer, warranties, capability, location, history, earlier services or repairs, ownership and other metadata associated with the respective object 10 or UE 18 (or more specifically the UE 18 associated with a certain user 16). It should be appreciated that it is also possible to aggregate several, i.e. two or more, objects under a common network entity profile 20, i.e., not all objects necessarily have their own individually unique IDs or network entity profiles 20 in the system 1. For example, if a user connects several location sensors at home this group of location sensors may be identified in the system 1 as one home location sensor.

The node 12 optionally includes a relation management function 22 which is configured to coordinate the interactions between the objects 10. This may e.g. be done by applying social management principles as discussed in WO 2011/080549. The node 12 can e.g. issue queries in order to establish relationships between network entities 10 and 18 by, for example, sending a network entity's profile 20 to a potentially relevant network entity 10, 18. A relationship is established by the relation management function 22 based on, e.g., a confirmation from the user(s) 16 via the UE(s) 18. Network entities 10, 18 can share temporal and permanent relationships with other network entities 10, 18. The node 12 may optionally also comprise a semantics function 24, which includes functionality that allows, e.g., device manufacturers, to establish devices with a brand-dependent semantic interaction language where applicable. Furthermore, the node 12 may interface with its objects 10 and/or users 16 (more specifically, the UEs 18 associated with the users 16) through a set of Application Programming Interfaces (APIs) 26 and 28. The node 12 may interface with objects 10 and UEs 18 in order to establish relationships using social mapping principles and also to exercise those relationships in performance of various tasks. Different user interactions can be used in order to manage the query/confirmation procedure. A user 16 could for example confirm a relationship query transmitted to its UE 18 by the relation management function 22 of the node 12 by operating and interacting with a user interface of a UE 18.

Example embodiments of the present invention will now be discussed with reference to a network of connectable and uniquely identifiable objects 10, like for example the system 1 presented with reference to FIG. 1 and discussed in detail in WO 2011/080549. A user (seller) who wants to put a certain object, e.g. object 10′, for sale may operate and interact with his/her UE 18. The UE 18 may, e.g., be a mobile telephone (sometimes referred to as smartphone, cellular phone, cellphone or the like) or a tablet computer. The UE 18 is connected to the network management node 12, which is connected to one or more objects 10 via the network 14. Each of the objects 10 comprises a unique network entity profile 20. The network entity profiles 20 may comprise static information pertaining to the objects 10 in question.

In a user scenario, one or more content objects are displayed, or otherwise presented, to the user 16 via a user interface of the UE 18. Each of the displayed content objects is associated with a respective object 10 of the system 1. A user who wants to sell a specific object 10 operates and interacts with the user interface of the UE 18 so as to select a certain content object (representing the object 10, which is intended for sale). The UE 18 is operable to detect this user interaction and, moreover, associate the user interaction with a selection of the specific content object. Furthermore, the UE 18 is operable to associate the user interaction with a sales offering request message for requesting a network management node 12 to offer the specific object associated with the selected content object for sale. Then, the UE 18 is operable to send, i.e. transmit, the sales offering request message to the network management node 12 for thereby requesting the network management node to offer the intended object for sale. The network management node 12 receives the sales offering request message from the UE 18. This sales offering request message requests the network management node 12 to offer the specific object 10′ (selected by the user 16 via his/her UE 18) for sale. When the network management node 12 has received the sales offering request message, it gathers information about the specific object from the unique network entity profile 20 associated with the specific object 10′. In one embodiment, the static information may be gathered from the network entity profile depository 20 (see FIG. 1). In another embodiment, the static information is gathered from an information element of the received sales offering request, wherein the information element comprises the unique network entity profile. Subsequently, the network management node 12 generates a sales advertisement, ad, for the specific object on the basis of the gathered information about the object 10′.

Since each of the objects 10 illustrated in FIG. 1 are represented by a unique network entity profile 20, there exists information about the objects 10 that can be utilized to generate, automatically or essentially automatically, a sales ad for the specific object in an ecommerce service like Amazon.com, Craiglist.org, eBay.com, or Blocket.se. This effectively enables the user (seller) to put the object 10′ up for sale by only a minimum of user interactions with a UE 18. Instead of manually entering or providing information for the sales ad, the user merely have to operate and interact with the UE so as to select one specific content object associated with an object 10 that is intended for sale. Then, the network management node 12 gathers any information for the sales ad and generates the sales ad, automatically or substantially automatically, on the basis of any gathered information pertaining to the object that is offered for sale.

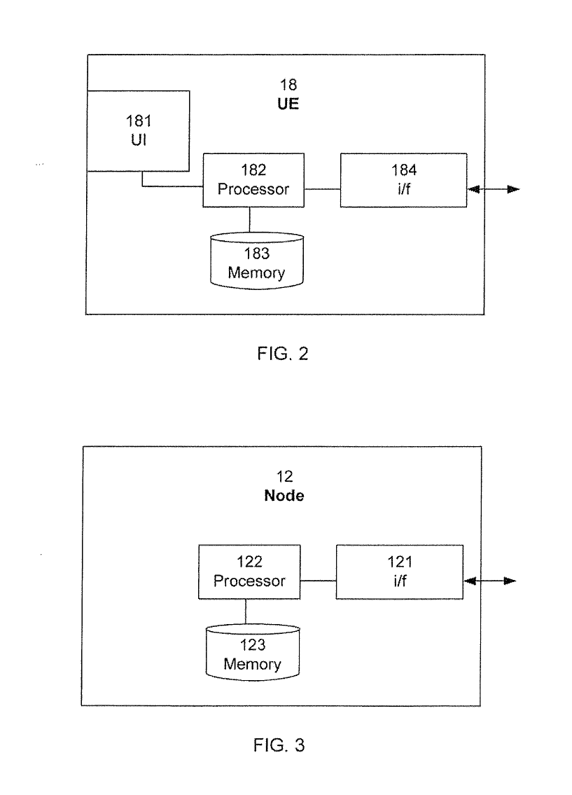

FIG. 2 is a schematic diagram illustrating some modules of an embodiment of an UE 18.

The UE 18, which may e.g. be embodied as a mobile telephone or tablet computer, is connectable to the network management node 12 (see FIG. 1). The network management node 12 is connectable to objects 10 via network 14 and each of the objects comprises a unique network entity profile 20 comprising static information pertaining to the object 10 in question. As is illustrated in FIG. 2, the UE 18 comprises a user interface 181 configured to display a plurality of content objects, wherein each of the plurality of content objects is associated with a respective object 10. The user interface 181 may e.g. comprise a touch screen display where the content objects are displayable as clickable objects or icons. A processor 182 may be provided using any suitable central processing unit (CPU), microcontroller, digital signal processor (DSP), etc., capable of executing computer program comprising computer program code, the computer program being stored in the memory 183. The memory 183 may be any combination of random access memory (RAM) and read only memory (ROM). The memory may also comprise persistent storage, which, for example, can be any single one or combination of magnetic memory, optical memory, or solid state memory or even remotely mounted memory.

The memory 183 stores a computer program comprising computer program code which, when run in the processor 182, causes the UE 18 to detect a user interaction with one content object displayed at the user interface 181, wherein the user interaction comprises a selection of one of the displayed content objects. The memory 183 and the computer program code are configured to, with the processor 182, further cause the UE 18 to associate the user interaction with a sales offering request message for requesting a network management node to offer a specific object associated with the selected content object for sale. Furthermore, the memory 183 and the computer program code are configured to, with the processor 182, further cause the UE 18 to send, via a communication interface 184, the sales offering request message to a network management node 12 for thereby requesting the network management node 12 to offer said object for sale.

In a preferred embodiment, the user interface 181 comprises a touch screen display. In this embodiment, the user interaction may be a trigger touch interaction (e.g., clicking the displayed, or otherwise presented, object/icon). A trigger touch interaction is a touch interaction where a certain function is performed. To this end, the processor 182 may be configured to detect and/or identify the trigger touch interaction and in response thereto trigger a certain function. For example, a certain content object may have a pre-defined association with a certain function such that when the processor 182 detects a trigger touch interaction on a certain content object, this will cause processor 182 to perform the certain function. One example is where a user performs the trigger touch interaction of clicking (touching) a specific content object. This causes the UE 18 to detect a user interaction with the specific content object displayed at the user interface 181, and the user interaction is detected as comprising a selection of the displayed content object. The memory 183 and the computer program code are configured to, with the processor 182, further cause the UE 18 to associate the user interaction with a sales offering request message for requesting a network management node to offer a specific object associated with the selected content object for sale, and to send, via the communication interface 184, the sales offering request message to a network management node 12 for thereby requesting the network management node 12 to offer said object for sale.

In one embodiment, the sales offering request comprises an information element for indicating which of the plurality of objects that is offered for sale by the user 16. In one embodiment, the sales offering request may optionally comprise an information element comprising the unique network entity profile of the object that is intended for sale. The sales offering request may additionally comprise an information element for requesting a publishing action. To this end, the memory 183 and the computer program code may be configured to, with the processor 182, further cause the UE 18 to send, via the communication interface 184, a publish request for publishing a sales ad.

FIG. 3 is a schematic diagram illustrating some modules of an embodiment of a network management node 12. The network management node 12 is suitable for offering an object 10 for sale. The network management node 12 is connectable to a plurality of objects 10 via the network 14. Each of the plurality of objects 10 is associated with a unique network entity profile 20 comprising static information pertaining to the object 10. As is illustrated in FIG. 3, the network management node 12 comprises a communication interface 121 configured to receive a sales offering request message from a UE 18. The sales offering request message is a message that requests the network management node 12 to offer a specific object 10 of the plurality of objects 10 for sale. A processor 122 may be provided using any suitable central processing unit (CPU), microcontroller, digital signal processor (DSP), etc., capable of executing computer program comprising computer program code, the computer program being stored in the memory 123. The memory 123 may be any combination of random access memory (RAM) and read only memory (ROM). The memory may also comprise persistent storage, which, for example, can be any single one or combination of magnetic memory, optical memory, or solid state memory or even remotely mounted memory.

The memory 123 stores a computer program comprising computer program code which, when run in the processor 122, causes the network management node 12 to gather static information about the specific object from the unique network entity profile associated with the specific object, and generate a sales ad for the specific object on the basis of the gathered static information about the object. The sales ad can, e.g., be generated as text describing the object 10′ and the static information can be presented along with the specific object 10′.

As used herein, static information is information pertaining to the object and which is generally fixed. Examples of static information included, but is not limited to, information such as name (e.g. object name), technical specifications, manufacturer, warranties, capability, location, history, earlier services or repairs, ownership and other metadata associated with the respective object 10.

In a preferred embodiment, the memory 123 and the computer program code are configured to, with the processor 122, further cause the network management node 12 to gather dynamic data about the specific object and furthermore generate the sales ad on the basis of the gathered dynamic information about the object. As used throughout this disclosure, the expression dynamic information refers to information that may change over time. Examples of static information included, but is not limited to information such as price information in other sales ads for the same object 10 or similar objects. For example, dynamic information can be gathered by node 12 from various content sources 15 (e.g. e-commerce sites), over the network 14, for example through API 28. For instance, the dynamic information may include information such as minimum/maximum price for the same object 10 or similar objects, or average price among a plurality of content sources 16 (e.g. e-commerce sites). Again, the sales ad can e.g. be generated as text describing the object 10 and the dynamic information can be presented along with the specific object 10.

Furthermore, the memory 123 and the computer program code may be configured to, with the processor 122, further cause the network management node 12 to gather data about a user associated with a user equipment from which a sales offering request is received and furthermore generate the sales ad on the basis of the gathered data about said user associated with the user equipment. In other words, according to some embodiment not only static information about the object 10 for sale is gathered, but also dynamic information and user-specific information can be gathered. User-specific information is any information relating to the user 16 of a particular UE and may, e.g., relate to user preferences.

In some embodiments, the sales offering request may further comprise an information element for requesting a publishing action. To this end, the memory 123 and the computer program code are configured to, with the processor 122, further cause the network management node 12 to send, i.e. transmit, a publish request via the communication interface 124. The publish request is a request for publishing the generated sales ad, such that the indicated object 10 is offered for sale.

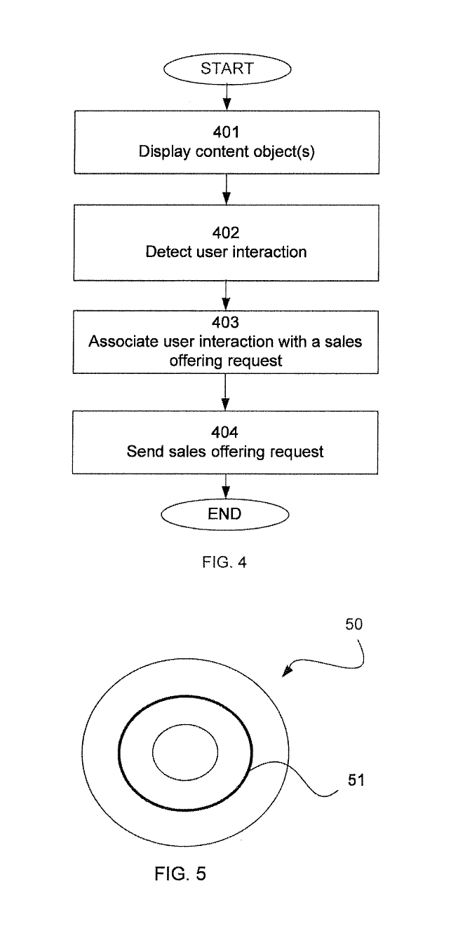

FIG. 4 illustrates a method performed by a UE 18 according to an exemplary embodiment of the present invention. The UE 18 is connected to a network management node 12, which in turn is connected to one or several objects 10 via the network 14. Each of the objects 10 comprises a unique network entity profile 20 comprising static information pertaining to the object 10. In a display step 401, one or several content objects are displayed, or otherwise presented, to a user 16 via a user interface of the UE. Each of the displayed or otherwise presented, content objects is associated with a respective object 10. In other words, the user 16 can be said to have access to a list or set of objects 10 of the system 1 (see FIG. 1). A user who wishes to put a specific object 10 for sale can operate and interact with the user interface of the UE. In a detection step 402, the UE 18 detects a user interaction with one content object displayed on the user interface of the UE, wherein the user interaction comprises a selection of one of the plurality of content objects. In an association step 403, the user interaction is associated with a sales offering request message for requesting a network management node to offer a specific object associated with the selected content object for sale. Subsequently, in a transmission step 204, the sales offering request message is sent, i.e. transmitted, to a network management node for thereby requesting the network management node to offer said object for sale. Optionally, the sales offering request comprises an information element comprising the unique network entity profile of the object 10, which is offered for sale. In some embodiments, the sales offering request also comprises an information element for indicating which of the plurality of objects 10 that is offered for sale. Moreover, in some embodiments, the sales offering request may further comprise an information element for requesting a publishing action. If so, the method further comprises sending a publish request for publishing a sales ad, such that the indicated object 10 is offered for sale.

FIG. 5 schematically shows one example of a computer program product 50 comprising computer readable means 51. On this computer readable means 51, a computer program can be stored, which computer program, when run on the processor 182 of the UE 18 100, can cause the UE 18 to execute the method according to various embodiments described in the present disclosure. In this illustrative example, the computer program product is an optical disc, such as a CD (compact disc), a DVD (digital versatile disc) or a blue-ray. However, in preferred embodiments the computer-readable means can also be solid state memory, such as flash memory or a software package (also sometimes referred to as software application, application or app) distributed over a network, such as the Internet.

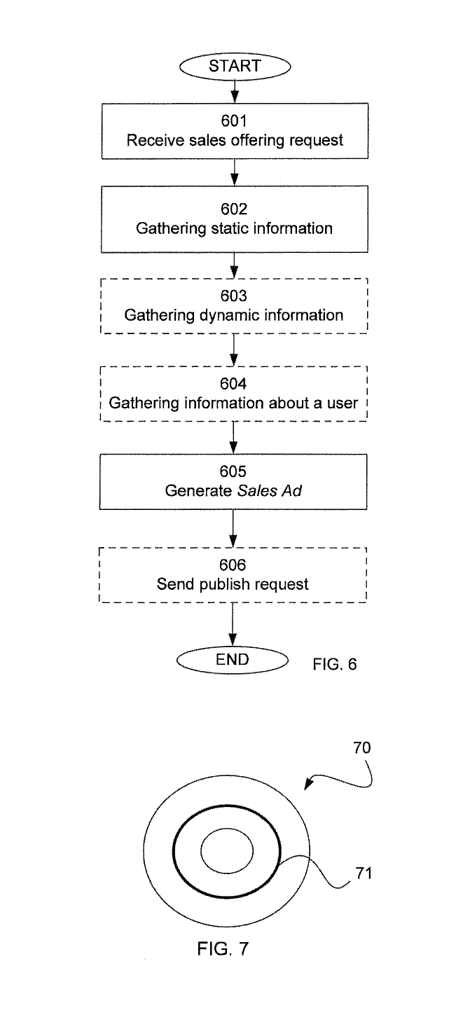

FIG. 6 illustrates a method performed by a network management node 12 according to an exemplary embodiment of the present invention. As is illustrated in FIG. 1, the network management node 12 can be connected to one or more objects 10 via the network 14. Each of the objects 10 is associated with a unique network entity profile comprising static information pertaining to the object 10. In a sales offering receipt step 601, the node 12 receives the sales offering request message from the UE 18. The sales offering request message requests the network management node 12 to offer a specific object 10 of the plurality of objects 10 for sale. In a subsequent gathering step 202, the node 12 gathers static information about the specific object 10. This is preferably done from the unique network entity profile associated with the specific object, because the unique network entity profile comprises static information pertaining to the specific object 10. When the static information has been gathered by the node, the method continues to a sales ad generating step 205. In the sales ad generating step, a sales advertisement, or sales ad, for the specific object 10 is generated on the basis of the gathered static information about the specific object 10. For example, the sales ad can be generated by using some or all of the static information pertaining to the object 10. The sales ad can e.g. be generated as text describing the object 10. In some embodiments, the sales offering request further comprises an information element for requesting a publishing action. In such embodiments, the method may further comprise sending a publish request for publishing the generated sales ad, such that the indicated object is offered for sale, e.g. at a certain e-commerce site such Amazon.com, Craiglist.org, eBay.com, or Blocket.se.

In a preferred embodiment, the method additionally comprises gathering dynamic information about the specific object 10 as described hereinabove. Dynamic information includes, but is not limited to, price information in other sales ads for the same object 10 or similar objects. For example, dynamic information can be gathered by node 12 from various e-commerce sites, for example through API 28 such that minimum/maximum price for the same object 10 or similar objects can be presented along with the specific object 10. If the method additionally comprises the step of gathering dynamic information, the generating step 205 further comprises generating the sales ad for the specific object on the basis of the gathered dynamic information about the object. For example, the sales ad can be generated by using some of the static information pertaining to the object 10. The sales ad can e.g. be generated as text describing the object 10.

In yet other embodiments, the method further comprises gathering information about a user associated with the UE 18 from which the sales offering request is received. If so, the generating step 205 may further generating the sales ad for the specific object on the basis of the gathered data about said user associated with the UE 18.

FIG. 7 schematically shows one example of a computer program product 70 comprising computer readable means 71. On this computer readable means 71, a computer program can be stored, which computer program, when run on the processor 122 of the node 12, can cause the node 12 to execute the method according to various embodiments described in the present disclosure. In this illustrative example, the computer program product is an optical disc, such as a CD (compact disc), a DVD (digital versatile disc) or a blue-ray. However, in preferred embodiments the computer-readable means can also be solid state memory, such as flash memory or a software package (also sometimes referred to as software application, application or app) distributed over a network 14, such as the Internet.

The herein disclosed embodiments of the present invention provide for a facilitated process of offering objects for sale. Since each object 10 of a system, like for example the system disclosed with reference to FIG. 1, comprises a unique network entity profile 20, there is information about the objects 10 that can be utilized to generate, automatically or essentially automatically, a sales ad for the specific object in an ecommerce service like Amazon.com, Craiglist.org, eBay.com, or Blocket.se. This effectively enables the user (seller) to put the object 10 up for sale by only a minimum of user interactions with a UE 18. Instead of manually entering or providing information for the sales ad, the user merely have to operate and interact with the UE so as to select one specific content object associated with an object 10 that is intended for sale. Then, the network management node 12 gathers any information (e.g. static, dynamic, and/or user-specific) for the sales ad and generates the sales ad, automatically or substantially automatically, on the basis of any gathered information pertaining to the object that is offered for sale. Compared with earlier e-commerce solutions, systems, methods and various devices of the present disclosure allows for a quicker process for putting objects for sale on sites such as Amazon.com, Craiglist.org, eBay.com, or Blocket.se. Also, since some embodiments allow for a minimum of user interactions when putting an object 10 for sale, embodiments of the present invention is attractive for users with no or little computer skills. Moreover, embodiments of the present invention allows for a user-friendly and intuitive process of offering objects for sale.

Although the present invention has been described above with reference to specific embodiments, it is not intended to be limited to the specific form set forth herein. Rather, the invention is limited only by the accompanying claims, and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A method performed by a network management node for offering an object for sale, wherein the network management node is connected to a plurality of objects via a network and wherein each of the plurality of objects is associated with a unique network entity profile comprising static information pertaining to the object, the method comprising:
receiving a sales offering request message from a user equipment, UE, the sales offering request message requesting the network management node to offer a specific object of the plurality of objects for sale;
gathering static information about the specific object from the unique network entity profile associated with the specific object; and generating a sales advertisement, ad, for the specific object on the basis of the gathered static information about the object.

2. The method according to claim 1, wherein the method further comprises gathering dynamic information about the specific object and wherein the step of generating the sales ad further comprises generating the sales ad for the specific object on the basis of the gathered dynamic information about the object.

3. The method according to claim 1, wherein the method further comprises gathering information about a user associated with the user equipment from which the sales offering request is received and wherein the step of generating the sales ad further comprises generating the sales ad for the specific object on the basis of the gathered data about said user associated with the user equipment.

4. The method according to claim 1, wherein the sales offering request further comprises an information element for requesting a publishing action and wherein the method further comprises sending a publish request for publishing the generated sales ad, such that the indicated object is offered for sale.

5. A network management node for offering an object for sale, wherein the network management node is connectable to a plurality of objects via a network and wherein each of the plurality of objects is associated with a unique network entity profile comprising static information pertaining to the object, the network management node comprising:
a communication interface configured to receive a sales offering request message from a user equipment, UE, the sales offering request message requesting the network management node to offer a specific object of the plurality of objects for sale;
a processor; and
a non-transitory memory storing a computer program comprising computer program code which, when run in the processor, causes the network management node to:
gather static information about the specific object from the unique network entity profile associated with the specific object; and
generate a sales advertisement, ad, for the specific object on the basis of the gathered static information about the object.

6. The network management node according to claim 5, wherein the memory and the computer program code are configured to, with the processor, further cause the network management node to gather dynamic data about the specific object and furthermore generate the sales ad on the basis of the gathered dynamic information about the object.

7. The network management node according to claim 5, wherein the memory and the computer program code are configured to, with the processor, further cause the network management node to gather data about a user associated with a user equipment from which a sales offering request is received and furthermore generate the sales ad on the basis of the gathered data about said user associated with the user equipment.

8. The network management node according to claim 5, wherein the sales offering request further comprises an information element for requesting a publishing action and wherein the memory and the computer program code are configured to, with the processor, further cause the network management node to send, via the communication interface, a publish request for publishing the generated sales ad, such that the indicated object is offered for sale.

9. A method performed by a user equipment. UE, for offering a object for sale, wherein the UE is connected to a network management node, which is connected to a plurality of objects via a network and wherein each of the plurality of objects comprises a unique network entity profile comprising static information pertaining to the object, the method comprising:
displaying a plurality of content objects via a user interface of the UE, wherein each of the plurality of content objects is associated with a respective object;
detecting a user interaction with one content object displayed on the user interface of the UE, the user interaction comprising a selection of one of the plurality of content objects;
associating the user interaction with a sales offering request message for requesting a network management node to offer a specific object associated with the selected content object for sale; and
sending the sales offering request message to a network management node for thereby requesting the network management node to offer said object for sale.

10. The method according to claim 9, wherein the sales offering request comprises an information element for indicating which of the plurality of objects that is offered for sale.

11. The method according to claim 9, wherein the sales offering request comprises an information element comprising the unique network entity profile of said objects for sale.

12. The method according to claim 9, wherein the sales offering request further comprises an information element for requesting a publishing action and wherein the method further comprises sending a publish request for publishing a sales ad, such that the indicated object is offered for sale.

13. A user equipment, UE, for offering a object for sale, wherein the UE is connectable to a network management node, which is connectable to a plurality of objects via a network and wherein each of the plurality of objects comprises a unique network entity profile comprising static information pertaining to the object, the UE comprising:
a user interface configured to display a plurality of content objects, wherein each of the plurality of content objects is associated with a respective object;
a processor; and
a non-transitory memory storing a computer program comprising computer program code which, when run in the processor, causes the UE to:
detect a user interaction with one content object displayed at the user interface, the user interaction comprising a selection of one of the plurality of content objects;
associate the user interaction with a sales offering request message for requesting a network management node to offer a specific object associated with the selected content object for sale; and
send, via a communication interface, the sales offering request message to a network management node for thereby requesting the network management node to offer said object for sale.

14. The UE according to claim 13, wherein the sales offering request comprises an information element for indicating which of the plurality of objects that is offered for sale.

15. The UE according to claim 13, wherein the sales offering request comprises an information element comprising the unique network entity profile of said objects for sale.

16. The UE according to claim 13, wherein the sales offering request further comprises an information element for requesting a publishing action and wherein the memory and the computer program code are configured to, with the processor, further cause the UE to send, via the communication interface, a publish request for publishing a sales ad, such that the indicated object is offered for sale.
